(19) United States
(12) Patent Application Publication
(10) Pub. No.: US 2017/0041861 A1
(43) Pub. Date: Feb. 9, 2017

(54) Method of Communicating to Selected Nodes in a Mesh Network

(71) Applicant: Amir Fuhrmann, Los Altos, CA (US)

(72) Inventor: Amir Fuhrmann, Los Altos, CA (US)

(21) Appl. No.: 15/231,358

(22) Filed: Aug. 8, 2016

Related U.S. Application Data
(60) Provisional application No. 62/201,764, filed on Aug. 6, 2015.

(51) Int. Cl. H04W 48/16; H04L 29/06; H04W 48/20; H04L 12/26

(52) U.S. Cl. CPC H04W 48/16; H04L 43/10; H04L 65/4076; H04W 48/20; H04W 84/18

(57) ABSTRACT

A method of communicating to selected nodes in a mesh network utilizes existing broadcasting methods to perform unicast communications in a mesh network. The method is performed by a system that includes a plurality of nodes. The plurality of nodes communicates through a key-value pair distribution system. The key-value distribution system is used to organize and manage communications between nodes. One of the nodes is configured as a controller node. The controller node is responsible for managing each of the remaining nodes. To do so, the controller node assigns a unique identifier to each of the remaining nodes. With the unique identifier, the controller node is able to address a specific node from the remaining nodes. As a result, direct communication may be directly established between the controller node and the specific node through the key-value pair distribution system.

The current application claims a priority to the U.S. Provisional Patent application Ser. No. 62/201,764 filed on Aug. 6, 2016. The current application is filed on Aug. 8, 2016 while Aug. 6, 2016 was on a weekend.

### FIELD OF THE INVENTION

The present invention relates generally to methods of communicating in a mesh network. More specifically, the present invention relates to unicasting messages to selected nodes through a key-value pair distribution system.

### BACKGROUND OF THE INVENTION

Mesh networks are commonly used to spread information across a plurality of nodes. Specifically, Bluetooth Low Energy (BLE) mesh networks are useful to connect multiple devices while requiring little energy to operate. As technology advances, towards developing everyday objects with network connectivity, mesh networking is becoming more and more prevalent. Existing mesh networks work by all messages to every node in the mesh network. While this practice is useful for relaying information to nodes not directly connected to the source of a message, continuously relaying information can ultimately lead to wasting energy.

Accordingly, there is a present need for a means of choosing which nodes are sent messages within a mesh network. The present invention is a method of communicating to selected nodes in a mesh network. The present invention leverages existing broadcasting methods in order to unicast messages to selected nodes using a key-value pair distribution system. Using the present invention, messages between a controller node and a specific node are sent using designated data slots from a plurality of indexed data slots. This helps to organize messages sent between the controller node and a plurality of remaining nodes. Further, the present invention helps to direct messages to the nodes associated to the messages.

### BRIEF DESCRIPTION OF THE DRAWINGS

FIG. 1 is a system diagram of the present invention.

FIG. 2 is a flowchart describing the general process of the present invention.

FIG. 3 is a flowchart describing the steps of organizing a plurality of indexed data slots provided to the key-value pair distribution system.

FIG. 4 is a flowchart describing the steps of joining the mesh network.

FIG. 5 is a flowchart describing the steps of allowing two nodes to join the mesh network simultaneously.

FIG. 6 is a flowchart describing the steps of activating the controller node and transmitting a heartbeat signal.

FIG. 7 is a flowchart describing the steps of accepting the specific node into the mesh network.

FIG. 8 is a flowchart describing the steps of assigning unallocated slots from the plurality of indexed data slots to the specific node.

FIG. 9 is a flowchart describing the steps of identifying one or more upstream designated slot and one or more downstream designated slot for communication between the controller node and the specific node.

FIG. 10 is a flowchart describing the steps of sending a message from the specific node to the controller node.

FIG. 11 is a flowchart describing the steps of sending a message from the controller node to the specific node.

FIG. 12 is a flow chart describing the steps of unassigning a pair of allocated slots to the specific node.

### DETAILED DESCRIPTION OF THE INVENTION

All illustrations of the drawings are for the purpose of describing selected versions of the present invention and are not intended to limit the scope of the present invention.

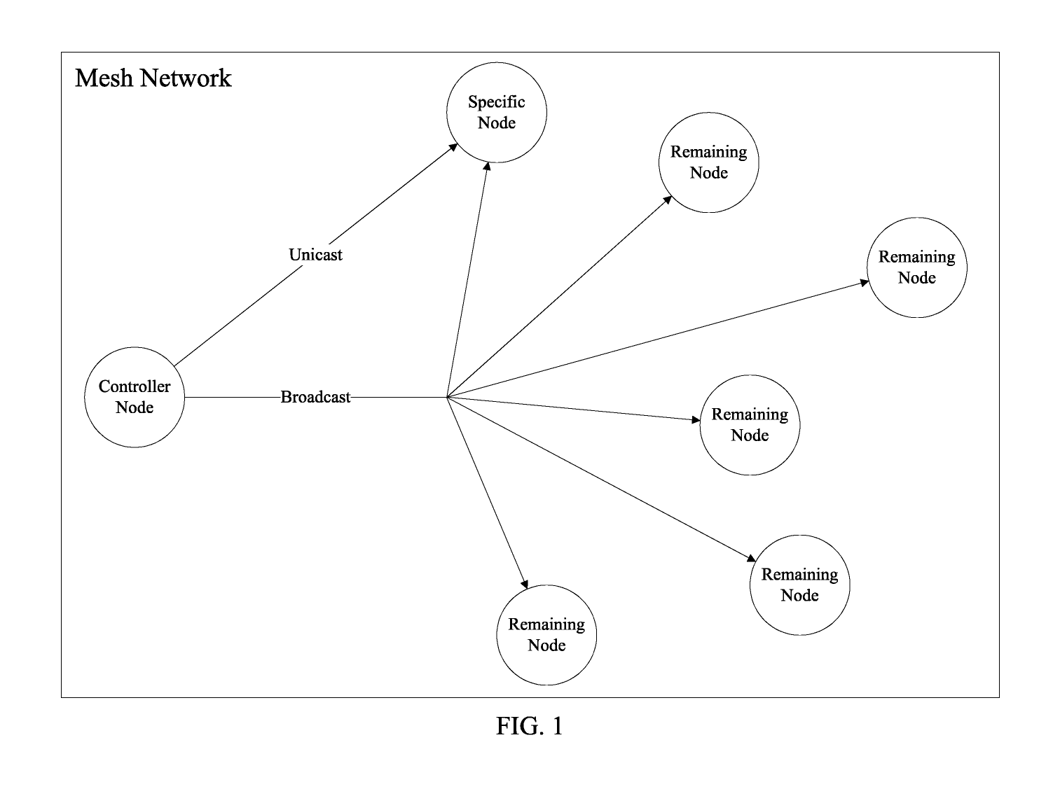

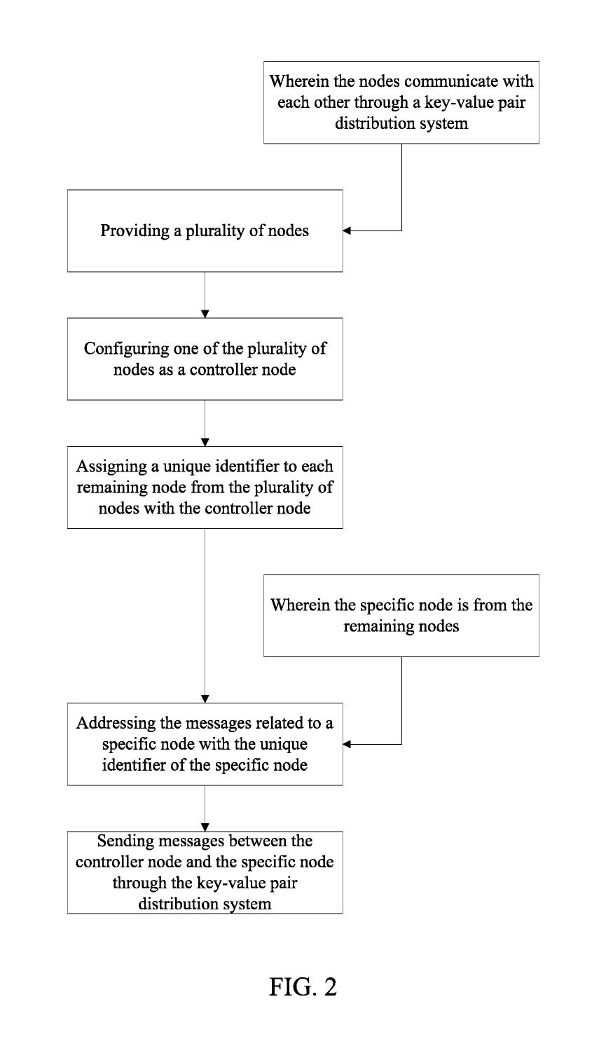

With reference to FIGS. 1-2, the present invention is a method of communicating to selected nodes in a mesh network. The present invention is used to selectively transfer messages to nodes rather than broadcast messages to all available nodes. The method of the present invention helps to improve the efficiency of a mesh network. In order to perform the method of the present invention, a system comprising a plurality of nodes is provided. The nodes communicate with each other through a key-value pair distribution system. The key-value pair distribution system shares information with each of the nodes, allowing information to be broadcasted to the plurality of nodes. The present invention leverages this functionality to unicast messages to selected nodes. One of the plurality of nodes is configured as a controller node. The controller node communicates with each of the remaining nodes and manages the functions of the remaining nodes. In order to differentiate between nodes, the controller node assigns a unique identifier to each remaining node from the plurality of nodes. Any messages related to a specific node from the remaining nodes are addressed with the unique identifier of the specific node. This allows messages to be unicast to the specific node. In the preferred embodiment of the present invention, an 8-bit chip is used for addressing messages to the remaining nodes. This limits the number of remaining nodes which can be used in the mesh network to 256, although alternative embodiments may have expanded capabilities. Messages are sent between the controller node and the specific node through the key-value pair distribution system. By addressing messages with the unique identifier, only a select number of key-value pairs are used to facilitate communications between the controller node and the selected node.

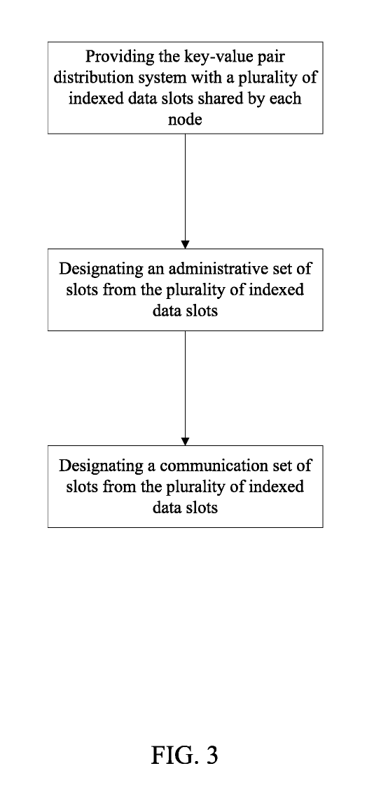

In reference to FIG. 3, a plurality of indexed data slots is provided to the key-value distribution system and is shared by each node. Each of the indexed data slots is used to hold key-value pairs, which, when updated, are used as a means of communication. An administrative set of slots is designated from the plurality of indexed data slots. The administration set of slots is used to handle general management operations for the mesh network. A communication set of slots is designated from the plurality of indexed data slots. The communication set of slots is used to facilitate communication between the controller node and each of the remaining nodes. In the preferred embodiment of the present invention, the first 15 indexed slots are designated as the administration set of slots and are used for allowing nodes to recognize the controller node, join the mesh network, and perform other duties. Moreover, in the preferred embodiment of the present invention, the communication set of slots is designated as the slots indexed from 16 to 155. As previously mentioned, the communication set of slots allows the controller node to communicate back and forth with each of the remaining nodes. Additional sets of slots may also be used for other functions.

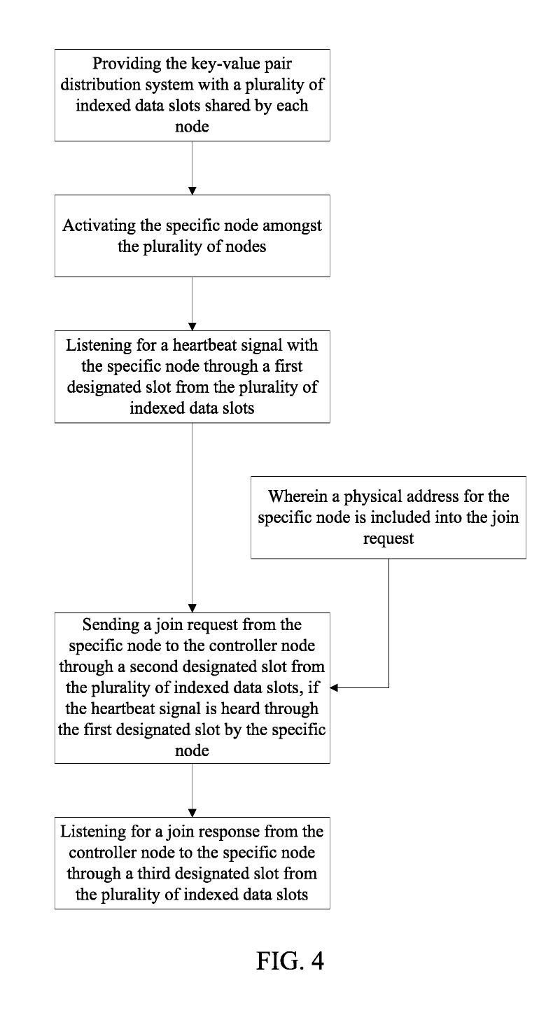

In order to add the specific node to the mesh network, the specific node is activated amongst the plurality of nodes. In reference to FIG. 4, the specific node listens for a heartbeat signal through a first designated slot from the plurality of indexed data slots. The heartbeat signal is used by the controller node as a means of verifying a connection with each of the remaining nodes. If the heartbeat signal is heard through the first designated slot by the specific node, then the specific node sends a join request back to the controller node through a second designated slot from the plurality of indexed data slots. A physical address for the specific node is included in the join request. The physical address for the specific node is used to verify that the specific node is permitted to join the mesh network and enable communications with the specific node. The specific node listens for a join response from the controller node through a third designated slot from the plurality of indexed data slots. Upon receiving a join response from the controller node, the specific node is permitted to join the mesh network.

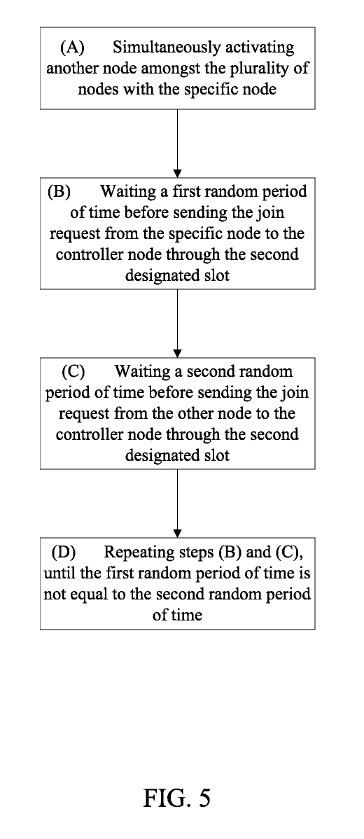

In reference to FIG. 5, because individual slots are used for sending and receiving join requests and join responses, only a single node is permitted to join the mesh network at any given time. Often, the specific node is simultaneously activated with another node amongst the plurality of nodes (Step A). To combat this, the specific node waits for a first random period of time before sending the join request to the controller node through the second designated slot (Step B). Further, the other node waits for a second random period of time before sending the join request to the controller node through the second designated slot (Step C). Because it is conceivable that the first random period of time and the second random period of time could coincidentally be the same, steps B and C are repeated until the first random period of time is not equal to the second random period of time (Step D). This is also done in the event that more than two nodes are attempting join the mesh network at a given time. In the preferred embodiment of the present invention, the first random period of time and the second random period of time are between one second and five seconds; however, varying periods of time may alternatively be used.

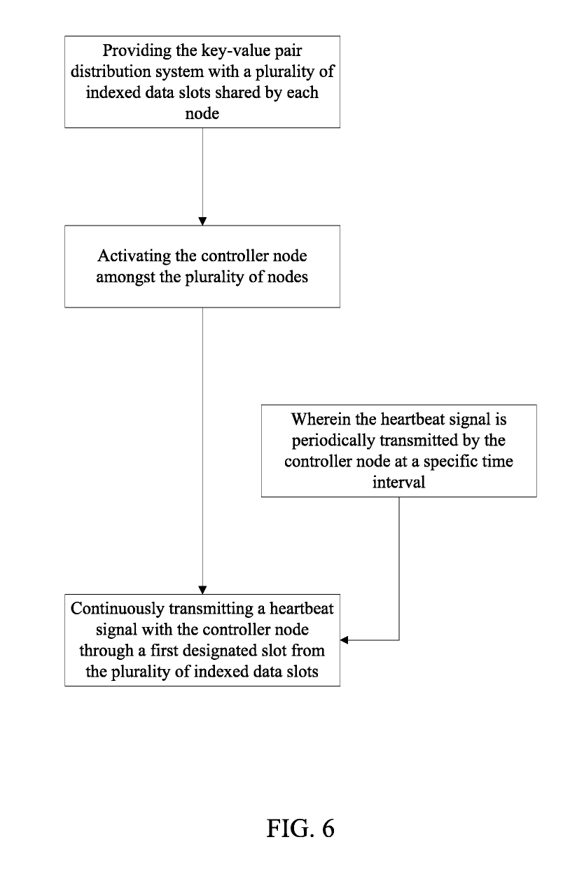

In reference to FIG. 6, when the controller node is activated amongst the plurality of nodes. The controller node continuously transmits the heartbeat signal through a first designated slot from the plurality of indexed data slots. Once the controller node begins transmitting the heartbeat signal, the remaining nodes may attempt to join the mesh network. In the preferred embodiment of the present invention, the heartbeat signal is periodically transmitted at a specific time interval so that a constant signal is not required.

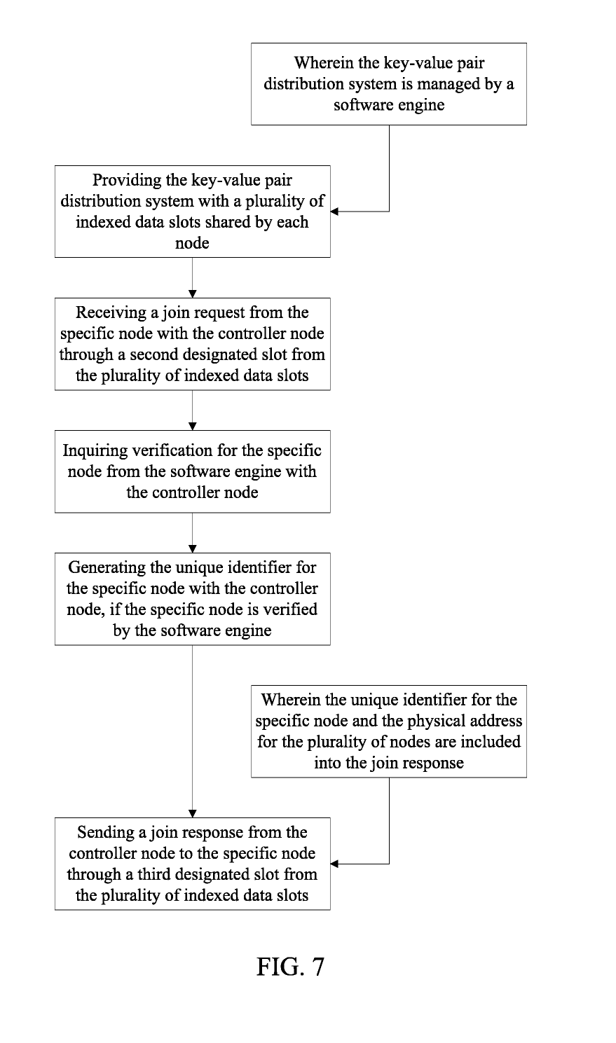

In the preferred embodiment of the present invention, the key-value pair distribution system is managed by a software engine. In reference to FIG. 7, the software engine is used to manage the mesh network in its entirety. When the controller node receives the join request from the specific node through the second data slot from the plurality of indexed data slots, then the software engine ultimately decides if the specific node may join the mesh network. The controller node inquires the software engine for verification of the specific node. The unique identifier is generated for the specific node only if the specific node is verified by the software engine. Upon receiving verification for the specific node, the controller node sends a join response through the third designated slot from the plurality of indexed data slots. The physical address for the plurality of nodes is included into the join response so that the selected node is able to communicate within the mesh network. In addition to the physical address of the plurality of nodes, the unique identifier for the specific node is included into the join response. This is done so that the selected node knows which indexed data slots to use when communicating with the controller node.

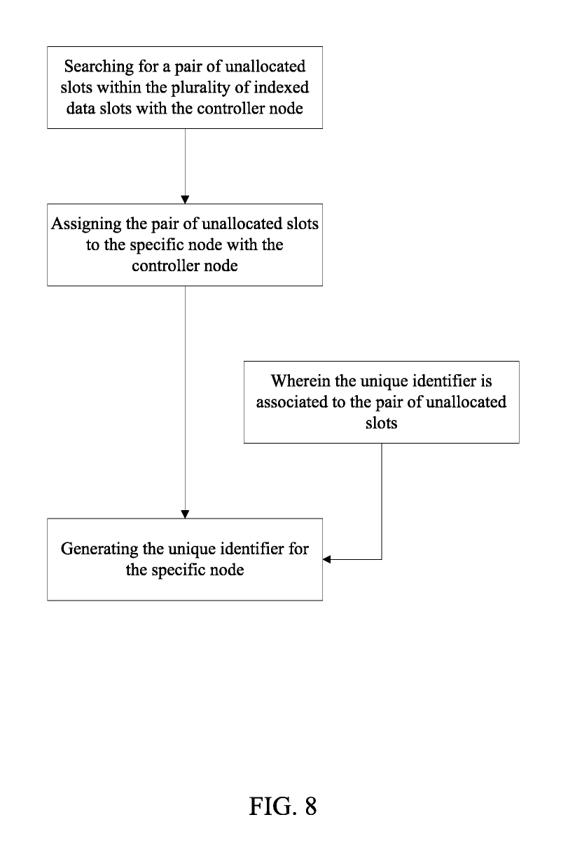

In reference to FIG. 8, before the unique identifier is generated for the specific node, the controller node searches for a pair of unallocated slots within the plurality of indexed data slots. The controller node looks for unallocated slots so that those unallocated slots may be specifically used for communications with the specific node. Upon finding the pair of unallocated slots, the pair of unallocated slots is assigned to the specific node. The unique identifier is generated for the specific node and is associated to the pair of unallocated slots. When the specific node receives the join response from the controller node, the included unique identifier is used by the specific node to find and access the pair of slots.

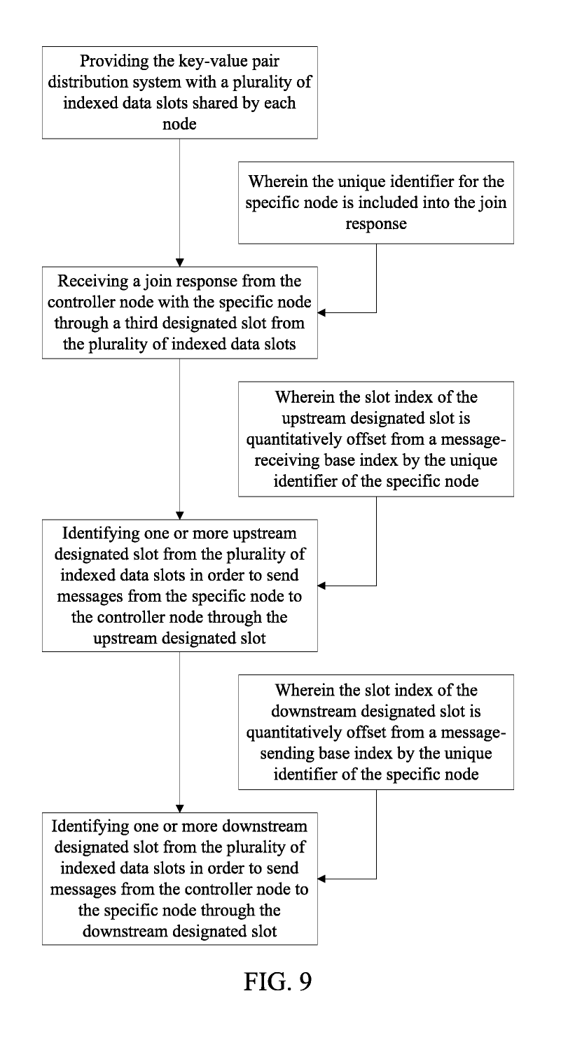

From the standpoint of the specific node, the specific node receives a join response from the controller node through a third designated slot from the plurality of indexed data slots. As previously mentioned, the unique identifier for the specific node is included into the join response. In reference to FIG. 9, the pair of slots that were associated to the unique identifier are used by the specific node for upstream and downstream communications with the controller node. One or more upstream designated slot is identified from the plurality of indexed data slots in order to send messages from the specific node to the controller node through the upstream designated slot. One or more downstream designated slot is identified from the plurality of indexed data slots in order to send messages from the controller node to the specific node through the downstream designated slot. This configuration is shared between the controller node and the specific node such that both nodes are able to distinguish the origin and meaning of a message.

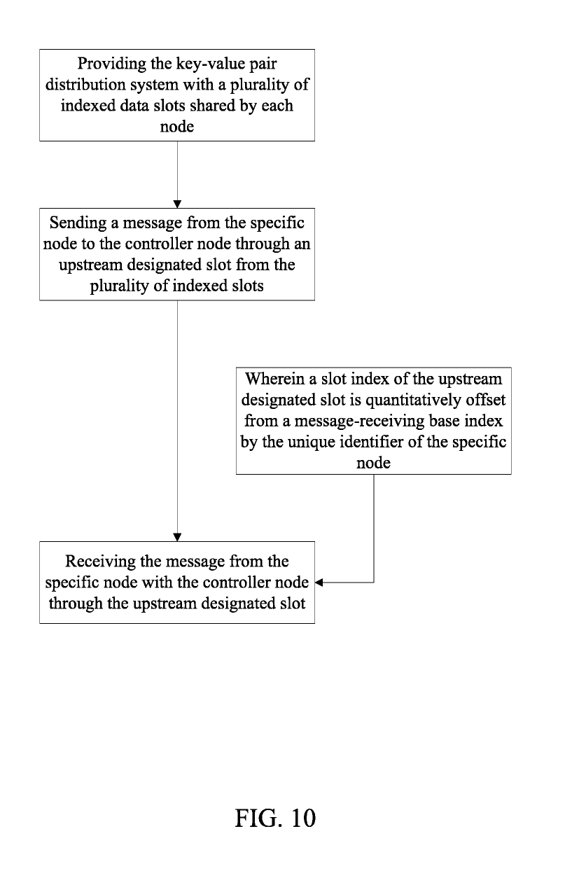

In reference to FIG. 10, because the mesh network may deal with a large number of nodes, the plurality of indexed data slots must be organized such that each node is able to identify and utilize slots easily. To do this, a slot index of the upstream designated slot is quantitatively offset from a message-receiving base index by the unique identifier of the specific node. The message-receiving base index is an arbitrary index used as a reference for all slots related to upstream communication. A slot index of the downstream designated slot is quantitatively offset from a message-sending base index by the unique identifier of the specific node. Similar to the message-receiving base index, the message-sending base index is an arbitrary index used as a reference for all slots related to upstream communication. In the preferred embodiment of the present invention, the message-receiving base index is designated as slot 16, while the message-sending base index is designated as slot 80. If, for example, the specific node had a unique identifier of 7, the specific node would send messages to the controller node with the 23^{rd} indexed data slot and receive messages with the 87^{th} indexed data slot. In using this configuration, the unique identifier for the specific node is directly tied to the upstream designated slot and the downstream designated slot. This helps to prevent nodes from accidentally using the wrong data slots.

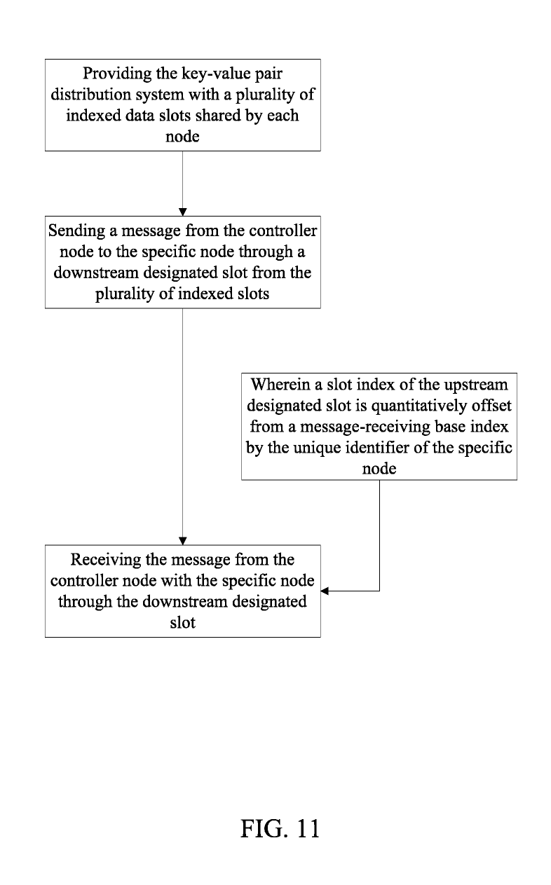

With the aforementioned configuration, the specific node sends a message to the controller node through the upstream designated slot from the plurality of indexed data slots. In reference to FIG. 11, the controller node then receives the message from the specific node through the upstream designated slot. Similarly, when the controller node sends a message to the specific node, the message is sent through the downstream designated slot from the plurality of indexed data slots. The controller node then receives the message from the specific node through the downstream designated slot. This practice is copied using other indexed data slots for additional nodes.

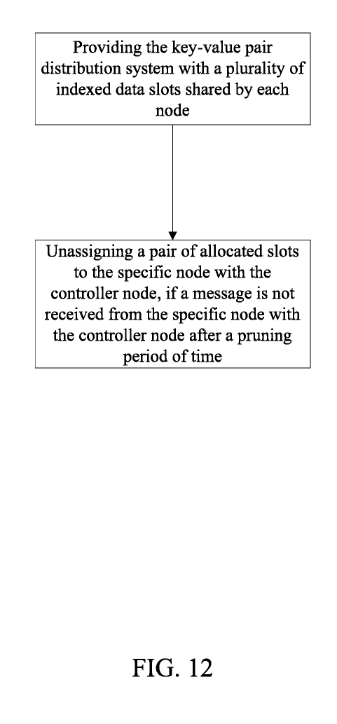

In reference to FIG. 12, in the event that nodes malfunction or otherwise disconnect from the mesh network, the controller node frees up any indexed data slots associated to the disconnected node. To do this, the controller node unassigns the pair of slots allocated to the specific node if the controller node does not receive a message from the specific node after a pruning period of time. The pruning period of time is an arbitrary amount of time used to determine if a node loses connection to the mesh network. In the preferred embodiment of the present invention, the pruning period of time is five seconds. Unassigning the pair of slots is done to recycle the pair of slots for use if another node is activated amongst the plurality of nodes. Because the unique identifier is associated to the pair of slots, the unique identifier may also be recycled. As a result, if the specific node disconnects from the mesh network and attempts to re-join, the specific node may be given a new unique identifier and subsequently use a different pair of indexed data slots.

Although the invention has been explained in relation to its preferred embodiment, it is to be understood that many other possible modifications and variations can be made without departing from the spirit and scope of the invention as hereinafter claimed.

What is claimed is:

1. A method of communicating to selected nodes in a mesh network, the method comprises the steps of:
providing a plurality of nodes, wherein the nodes communicate with each other through a key-value pair distribution system;
configuring one of the plurality of nodes as a controller node;
assigning a unique identifier to each remaining node from the plurality of nodes with the controller node;
addressing messages related to a specific node with the unique identifier of the specific node, wherein the specific node is from the remaining nodes; and
sending messages between the controller node and the specific node through the key-value pair distribution system.

2. The method of communicating to selected nodes in a mesh network as claimed in claim 1 comprises:
providing the key-value pair distribution system with a plurality of indexed data slots shared by each node;
designating an administrative set of slots from the plurality of indexed data slots; and
designating a communication set of slots from the plurality of indexed data slots.

3. The method of communicating to selected nodes in a mesh network as claimed in claim 1 comprises:
providing the key-value pair distribution system with a plurality of indexed data slots shared by each node;
activating the specific node amongst the plurality of nodes;
listening for a heartbeat signal with the specific node through a first designated slot from the plurality of indexed data slots;
sending a join request from the specific node to the controller node through a second designated slot from the plurality of indexed data slots,
if the heartbeat signal is heard through the first designated slot by the specific node; and
listening for a join response from the controller node to the specific node through a third designated slot from the plurality of indexed data slots.

4. The method of communicating to selected nodes in a mesh network as claimed in claim 3 comprises:
(A) simultaneously activating another node amongst the plurality of nodes with the specific node;
(B) waiting a first random period of time before sending the join request from the specific node to the controller node through the second designated slot;
(C) waiting a second random period of time before sending the join request from the other node to the controller node through the second designated slot; and
(D) repeating steps (B) and (C), until the first random period of time is not equal to the second random period of time.

5. The method of communicating to selected nodes in a mesh network as claimed in claim 3, wherein a physical address for the specific node is included into the join request.

6. The method of communicating to selected nodes in a mesh network as claimed in claim 1 comprises:
providing the key-value pair distribution system with a plurality of indexed data slots shared by each node;
activating the controller node amongst the plurality of nodes; and
continuously transmitting a heartbeat signal with the controller node through a first designated slot from the plurality of indexed data slots.

7. The method of communicating to selected nodes in a mesh network as claimed in claim 6, wherein the heartbeat signal is periodically transmitted by the controller node at a specified time interval.

8. The method of communicating to selected nodes in a mesh network as claimed in claim 1 comprises:
providing the key-value pair distribution system with a plurality of indexed data slots shared by each node, wherein the key-value pair distribution system is managed by a software engine;
receiving a join request from the specific node with the controller node through a second designated slot from the plurality of indexed data slots;
inquiring verification for the specific node from the software engine with the controller node;
generating the unique identifier for the specific node with the controller node,
if the specific node is verified by the software engine; and
sending a join response from the controller node to the specific node through a third designated slot from the plurality of indexed data slots, wherein the unique identifier for the specific node is included into the join response.

9. The method of communicating to selected nodes in a mesh network as claimed in claim 8, wherein a physical address for the plurality of nodes is included into the join response.

10. The method of communicating to selected nodes in a mesh network as claimed in claim 8 comprises:
searching for a pair of unallocated slots within the plurality of indexed data slots with the controller node;
assigning the pair of unallocated slots to the specific node with the controller node; and
generating the unique identifier for the specific node, wherein the unique identifier is associated to the pair of unallocated slots.

11. The method of communicating to selected nodes in a mesh network as claimed in claim 1 comprises:
providing the key-value pair distribution system with a plurality of indexed data slots shared by each node;
receiving a join response from the controller node with the specific node through a third designated slot from the plurality of indexed data slots, wherein the unique identifier for the specific node is included into the join response;
identifying one or more upstream designated slot from the plurality of indexed data slots in order to send messages from the specific node to the controller node through the upstream designated slot; and
identifying one or more downstream designated slot from the plurality of indexed data slots in order to send messages from the controller node to the specific node through the downstream designated slot.

12. The method of communicating to selected nodes in a mesh network as claimed in claim 11, wherein a slot index of the upstream designated slot is quantitatively offset from a message-receiving base index by the unique identifier of the specific node.

13. The method of communicating to selected nodes in a mesh network as claimed in claim 11, wherein a slot index of the downstream designated slot is quantitatively offset from a message-sending base index by the unique identifier of the specific node.

14. The method of communicating to selected nodes in a mesh network as claimed in claim 1 comprises:
providing the key-value pair distribution system with a plurality of indexed data slots shared by each node;
sending a message from the specific node to the controller node through an upstream designated slot from the plurality of indexed data slots; and
receiving the message from the specific node with the controller node through the upstream designated slot.

15. The method of communicating to selected nodes in a mesh network as claimed in claim 14, wherein a slot index of the upstream designated slot is quantitatively offset from a message-receiving base index by the unique identifier of the specific node.

16. The method of communicating to selected nodes in a mesh network as claimed in claim 1 comprises:
providing the key-value pair distribution system with a plurality of indexed data slots shared by each node;
sending a message from the controller node to the specific node through a downstream designated slot from the plurality of indexed data slots; and
receiving the message from the controller node with the specific node through the downstream designated slot.

17. The method of communicating to selected nodes in a mesh network as claimed in claim 16, wherein a slot index of the downstream designated slot is quantitatively offset from a message-sending base index by the unique identifier of the specific node.

18. The method of communicating to selected nodes in a mesh network as claimed in claim 1 comprises:
providing the key-value pair distribution system with a plurality of indexed data slots shared by each node; and
unassigning a pair of allocated slots to the specific node with the controller node,
if a message is not received from the specific node with the controller node after a pruning period of time.
